(19) United States
(12) Patent Application Publication
(10) Pub. No.: US 2014/0028249 A1
(43) Pub. Date: Jan. 30, 2014

(54) PULSE CHARGING OF A GRID INTERACTIVE BATTERY SYSTEM

(71) Applicant: Primus Power Corporation, Hayward, CA (US)

(72) Inventors: Ryan Larsen, San Francisco, CA (US); David Ridley, Hayward, CA (US); Rick Winter, Orinda, CA (US)

(73) Assignee: Primus Power Corporation, Hayward, CA (US)

(21) Appl. No.: 13/952,940

(22) Filed: Jul. 29, 2013

Related U.S. Application Data
(60) Provisional application No. 61/677,296, filed on Jul. 30, 2012.

(51) Int. Cl. H02J 7/02

(52) U.S. Cl. CPC H02J 7/022
USPC 320/107; 320/141

(57) ABSTRACT

A system for pulse charging a battery includes a battery module, an inverter, and a pulse apparatus connected to the inverter and the battery module and configured to pulse charge the battery module by modulating a power output from the inverter. A method of pulse charging a battery module includes the steps of converting AC power output from a power grid to constant DC power, modulating the constant DC power to produce modulated power, and providing the modulated power to the battery module to pulse charge the battery module.

### CROSS-REFERENCE TO RELATED APPLICATION

This application claims the benefit of priority to U.S. Provisional Patent Application Ser. No.: 61/677,296 entitled “Pulse Charging of a Grid Interactive Battery System” filed Jul. 30, 2012, which is incorporated herein by reference in its entirety.

### BACKGROUND

The development of renewable energy sources has revitalized the need for large-scale batteries for off-peak energy storage. The requirements for such an application differ from those of other types of rechargeable batteries such as lead-acid batteries. Batteries for off-peak energy storage in the power grid generally are required to be of low capital cost, long cycle life, high efficiency, and low maintenance.

One type of electrochemical energy system suitable for such energy storage is a so-called “flow battery” which uses a halogen component for reduction at a normally positive electrode (e.g., a liquid permeable electrode), and an oxidizable metal adapted to become oxidized at a normally negative electrode (e.g., a liquid impermeable electrode) during the normal operation of the electrochemical system. An aqueous metal halide electrolyte from a separate storage reservoir is used to replenish the supply of halogen component as it becomes reduced at the positive electrode. The electrolyte is circulated between the electrode area (e.g., in a stack of electrode cells) and a reservoir area. One example of such a system uses zinc as the metal and chlorine and/or bromine as the halogen.

Such electrochemical energy systems are described in, for example, U.S. Pat. No. 3,713,888, 3,993,502, 4,001,036, 4,072,540, 4,146,680, 4,414,292, and 8,114,541, the disclosures of which are hereby incorporated by reference in their entirety.

### SUMMARY

Various embodiments include a system for pulse charging a battery includes a battery module, an inverter, and a pulse apparatus connected to the inverter and the battery module and configured to pulse charge the battery module by modulating a power output from the inverter.

Further embodiments include a method of pulse charging a battery module includes the steps of converting AC power output from a power grid to constant DC power, modulating the constant DC power to produce modulated power, and providing the modulated power to the battery module to pulse charge the battery module.

### BRIEF DESCRIPTION OF THE DRAWINGS

FIG. 1 is a schematic diagram of a collection of battery modules tied to a power grid.

FIGS. 2A-H are pulsed waveforms that may be used in various embodiments.

FIG. 2I is a plot of current density versus time to illustrate a pulse profile with shorter periodic anodic pulses following longer cathodic pulses according to an embodiment.

FIG. 3 is a schematic diagram of an embodiment system with a regenerative pulsing load connected to a collection of battery modules.

FIG. 4 a schematic diagram of an embodiment system with a resistive load connected to a collection of battery modules via a power switching device.

FIG. 5A is a schematic diagram of an embodiment system with an H-bridge circuit connected to a battery module.

FIG. 5B is a schematic diagram of an embodiment system with multiple H-bridge circuits connected to battery modules.

### DETAILED DESCRIPTION

Various embodiments provide systems for pulse charging a collection of battery modules tied to a power grid. The various embodiments may comprise one or more alternate pulse apparatuses or sub-systems configured to pulse charge the battery collection, such as a flow battery, by modulating a constant power output from a power grid.

Pulse charging is a well-known concept that is already available on many power supplies and inverters. However, one of the main requirements of a grid energy storage system is to provide stability to the grid on which it operates. The present inventors realized that pulse charging as currently implemented conflicts with this requirement by rapidly oscillating the direction of current flow to and from the grid.

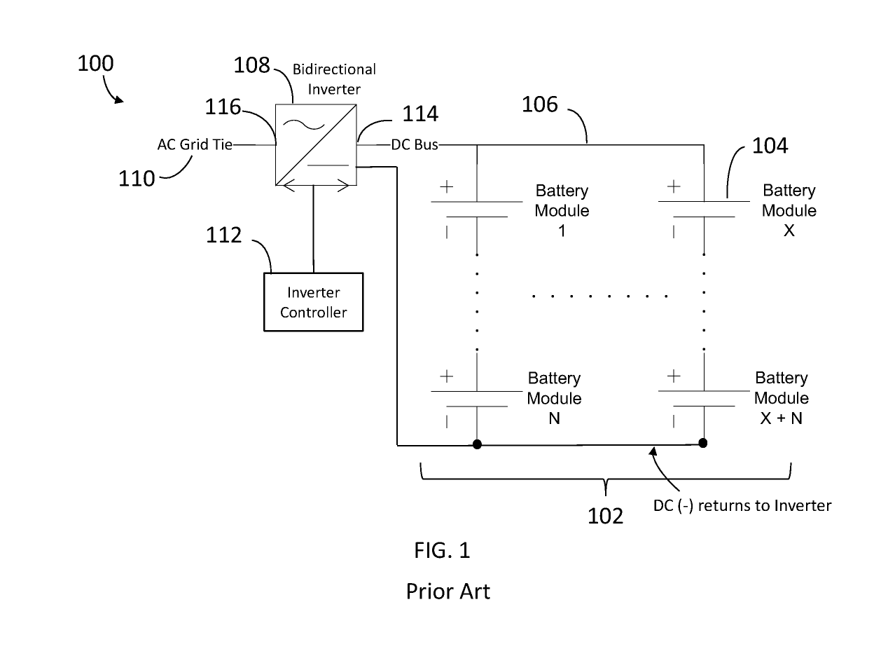

FIG. 1 illustrates a prior art system 100 with a battery collection tied to a grid. A battery collection 102 may comprise one or more battery modules 104 connected with a direct current (i.e., DC) bus 106. The direct current bus 106 may be connected to a power grid 110 (i.e., the AC or primary side) via a bidirectional inverter 108. The bidirectional inverter 108 may have an AC input/output 116 and a DC input/output 114. The bidirectional inverter 108 may be connected to a controller 112.

Previous systems, such as the system 100 shown in FIG. 1, rapidly oscillate the direction of current flow to and from the grid in order to pulse charge batteries (e.g., the controller 112 may control the amount and direction of current flowing through the inverter 108). In contrast, various embodiments of the present invention may allow the current and/or voltage drawn from the grid to remain constant (e.g., current and voltage at the DC input/output 114 may be constant) and may therefore maintain a low total harmonic distortion. For example, a pulse apparatus as described below may superimpose a waveform on the constant power output from the grid. The combination may be a periodic pulsed waveform with cathodic and anodic pulses which will result in net positive energy being transferred to battery modules.

The pulse charging apparatus may operate during battery charging cycles to provide the period power pulsing waveform. A pulse waveform is desirable for any battery system in which metal deposition via electroplating is taking place during charging, such as in flow batteries.

The pulsed waveform helps smooth metal deposition. Pulse plating is a method of electrodeposition of a metal or an alloy by means of variation, periodic reversal and/or stoppage of a direct current or potential. This is in contrast to continuous direct current (DC) used in conventional plating. The pulses can be classified into two main categories: unipolar and bipolar. In unipolar pulse plating, all pulses are in one direction. That is, all of the pulses are either applied with a positive potential or with a negative potential. In bipolar pulse plating, both positive and negative pulses are used. That is, both anodic and cathodic currents are used sequentially.

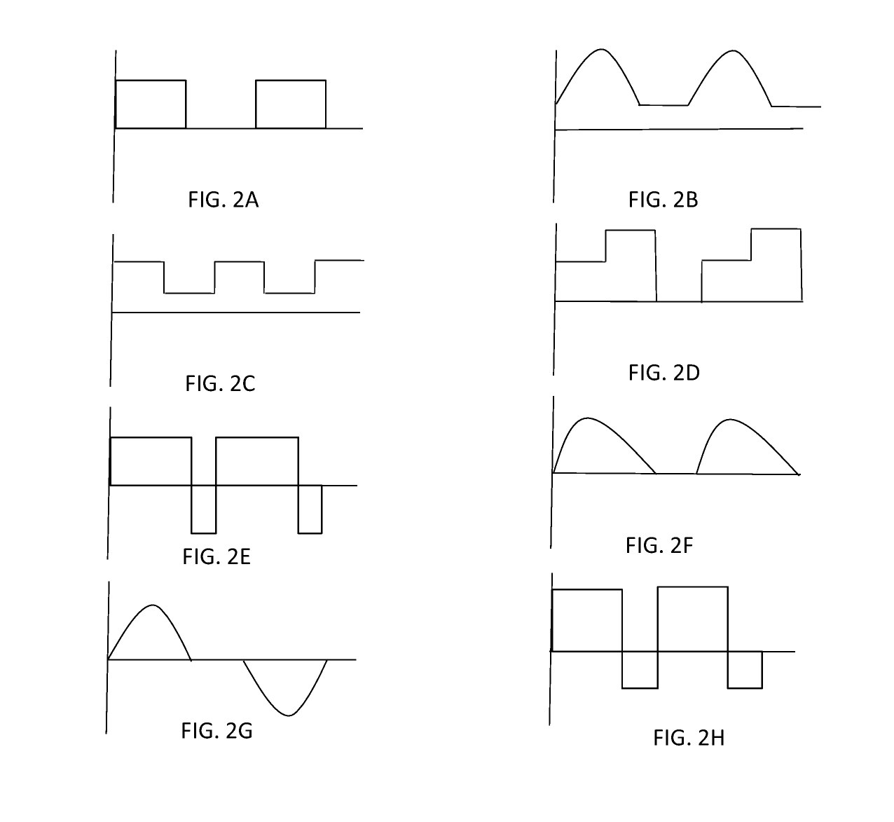

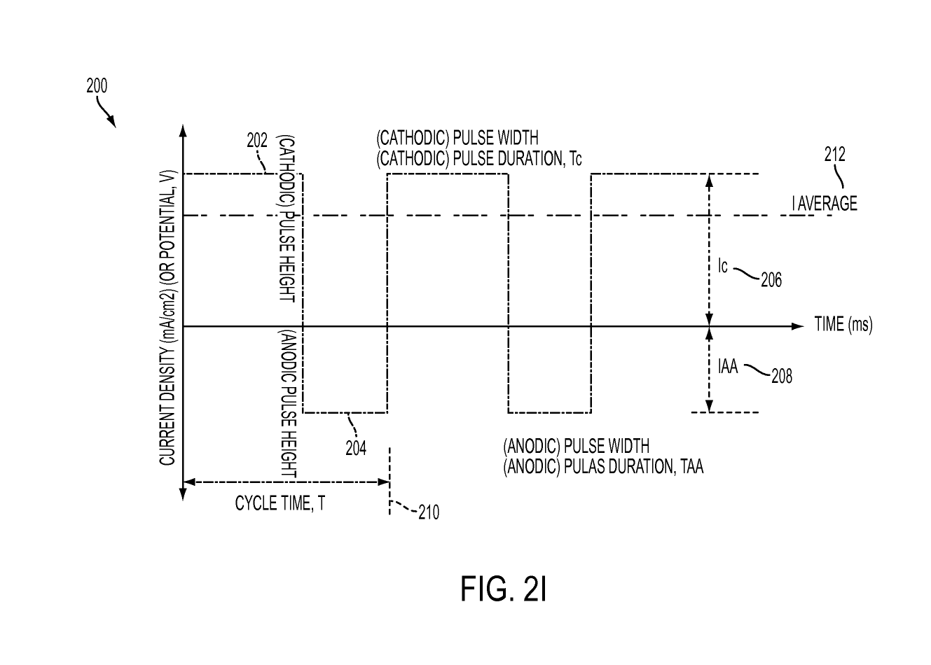

In addition to anodic and cathodic pulses, brief periods without current (non-current pulses) may also be used. Further, anodic, cathodic and non-current pulses may be combined with each other and/or with a continuous direct current. Example combinations/variations include, but are not limited to: (1) cathodic pulses followed by a period without current (or anodic pulse), (2) direct current with superimposed modulations, (3) duplex pulse—duplex pulse systems feature a burst of pulses at one level followed by a burst at another, all in one direction, (4) pulse on pulse—pulse-on-pulse systems offer complex wave shapes that have pulses of higher amplitude riding on top of those of lower amplitude, (5) pulse reverse current—cathodic plating pulse followed by anodic stripping pulse, (6) superimposing periodic reverse on high frequency pulse—this is a sine wave output pulse with a faster turn-on time (T_{ON}) and a slower sinusoidal turn-off time (T_{OFF}), (7) modified sine-wave pulse—in this modification, the output remains at zero for a predetermined amount of time before switching to either positive or negative and (8) square-wave pulses. Examples of these various waveforms (1)-(8) are illustrated in FIGS. 2A-H, respectively.

A particular type of pulse profile may be chosen based on the nature of the application and the final outcome desired. The response of the electrochemical system to which the pulse plating technique is applied is another consideration when selecting the pulse profile.

The metal-halogen electrochemical system (e.g., flow battery) response to the pulse plating is fast and effective. Moreover, excellent results in depositing high zinc loading with smooth morphology may be achieved with (i) cathodic pulse (positive current, i.e. from a positive potential applied to the cell) followed by a period in which anodic current (negative current, i.e. from a negative potential applied to the cell) in passed, and (ii) a pulse plating profile where cathodic pulse is followed by a period of anodic pulse and no current.

FIG. 2I illustrates the pulse plating profile having cathodic pulse followed by a period in which anodic current in passed. The pulses are illustrated as square waves. However, as discussed above, the pulses may have a sinusoidal or other shape. Characteristic features of the pulses as illustrated in FIG. 2I include: the cathodic pulse height I_{C} 206 (i.e., voltage or current density amplitude), the anodic pulse height I_{AA} 208, the cathodic pulse width or duration T_{C} 202, the anodic pulse width or duration T_{AA} 204, and the cycle time T 210 (where T=T_{C}+T_{AA}).

In various embodiments, the pulse apparatus may be configured to control frequency, duty cycle and amplitude of the pulse charging of the battery collection. For example, the frequency f of the pulses may be defined as f=1/(T_{ON}+T_{OFF})=1/(Total Time). The duty cycle γ is the ratio of the duration of the time on to the total pulse width, γ=T_{ON}/(T_{ON}+T_{OFF})=T_{C}/(T_{AA}+T_{C}). The average current density amplitude, I_{A}, 212 is equal to the product of the peak current and the duty cycle, I_{A}=Iₚ×γ=(I_{C}T_{C}−I_{AA}T_{AA})/(T_{AA}+T_{C}+T_{off}).

Further, the controlled pulse frequency (selecting or varying the cathodic pulse time/width) allows for controlling the grain growth dynamics, size and orientation. With optimized cathodic pulse frequency, the number of grains per unit area can be increased to provide a finer and more uniform deposit with better mechanical properties.

Very short anodic pulses (e.g., 1 ms to 100 s, 10 ms to 1 s, 100 ms-10 s, 1 s-100 s, 1 s-10 s) with high current density advantageously provide the leveling and the smoothing effect by dissolution of the protruding areas of the plated zinc deposit on the impermeable electrodes of the flow battery cells. Further, periodic anodic pulses may significantly raise the limiting current density (I_{L}) by replenishing metal ions in the diffusion layer continuously and allowing depositing at higher average current density.

Off-time pulses allow desorption of impurities from the impermeable electrode. The relaxation after an off pulse lowers the ionic potential at the electrode surface, thereby allowing more effective diffusion of plating species (e.g., zinc) to the electrode surface. Off-time pulses may also control the composition and thickness of the deposited film (e.g., zinc film on the impermeable electrode) in an atomic order.

In addition to providing a smooth layer of plated metal, pulse plating may provide one or more of the following advantages: (1) elimination of the additives, (2) reduced process (e.g. deposition) time, (3) increased throwing power, (4) better metallurgical properties (e.g. density, mechanical strength, ductility) of the deposit, (5) reduced tensile and internal stress of the deposit and (6) reduced hydrogen embrittlement. In embodiments, the application of pulse plating allows the complete elimination of the addition of additives in the battery electrolyte. Longer term use of additives, especially organic additives, in the acidic battery electrolyte results in degradation of the additives. Thus, the electrolyte may include an aqueous metal-halide electrolyte which lacks intentionally added additives, such as organic compounds. However, the electrolyte may still include hydrogen complexing agents (e.g., MEP) for bromine based flow batteries and/or unavoidable impurities besides water, metal (e.g., zinc), halogen ions (e.g., chlorine and/or bromine), and metal-halide compounds (e.g., ZnCl₂ and/or ZnBr₂). In addition to eliminating the use of additives, pulse plating also helps to reduce the raw material requirement in the bath, thereby reducing the process limitations. Elimination of the additives may also improve the deposit ductility and electrical conductivity, thereby improving voltaic efficiency of the battery.

Reduced process time enables smooth zinc deposition at higher current and hence reduces plating time by 10-20%. This increases the charging rate of the battery. Increased throwing power enables improved deposit homogeneity. Throwing power is the ability of a plating solution to produce a relatively uniform distribution of metal upon a cathode of irregular shape. Better metallurgical properties of the deposit are evidenced by a more fine grained (nm rather than micron average grain size zinc deposit) and denser and harder deposit with lower porosity. This not only helps to increase the plating efficiency and columbic efficiency of the battery but also dramatically reduces corrosion. A denser deposit has smaller surface area and a smaller surface area provides less support for less efficient (corrosion) chemical reactions. Pulse plating enables production of a more desirable elongated lamellar structure with higher tensile strength and reduced internal stress, which results in reduced tensile and internal stresses. This greatly results in enhanced adhesion of zinc to the substrate and reduces the peeling of zinc at higher loading. Pulse plating may also result in reduced hydrogen being trapped in the plated layer as it grows resulting in less hydrogen embrittlement.

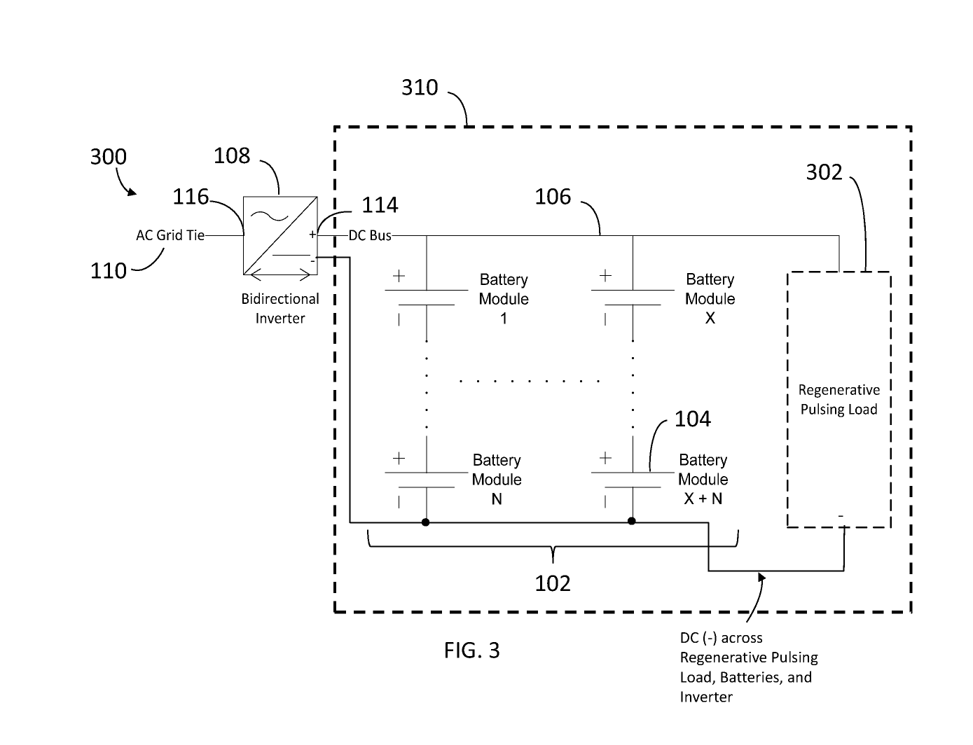

FIG. 3 illustrates an embodiment system 300. The pulse apparatus may be a regenerative pulsing load 302 electrically connected (e.g., in parallel) to a battery collection 102 including at least one battery module 104 by a DC bus 106. The DC bus 106 may be connected to a power grid 110 via a bidirectional inverter 108. The battery module 104 may comprise a flow battery module or another battery module comprising a stack of electrodes and an electrolyte. A flow battery module comprises a stack of anode and cathode electrodes, a separate electrolyte reservoir and at least one pump used to pump the electrolyte to and/or from the stack.

The regenerative pulsing load 302 may include a regenerative DC chopper circuit which will absorb energy to create the anodic pulses and return that energy to the batteries to create the cathodic pulses, thereby wasting very little energy. For example, the regenerative pulsing load 302 may include a power storage device (e.g., one or more capacitors or batteries that may have relatively small storage capacity compared to the battery modules 104 but that may cycle more quickly and more frequently) that charges and discharges power and is controlled by various logic elements, such as relays or transistors that switch at the desired pulse frequency. In alternate embodiments, various different chopper circuits and various different means for absorbing and returning energy may be used.

Embodiment system 300 may allow the current and/or voltage drawn from the grid to remain constant (e.g., current and/or voltage at the DC input/output 114 may be constant) and may therefore maintain a low total harmonic distortion. Rather than using a controller to rapidly oscillate the direction of current through the inverter 108 in order to create pulses as in the prior art, the inverter 108 may be passive (e.g., the inverter may still be bidirectional to allow charging and discharging from the battery modules but may not be responsible for pulsing and/or may not be connected to the inverter controller 112 as in FIG. 1) and the battery circuit portion 310 may be responsible for pulses (e.g., the regenerative pulsing load 302 may modulate the DC power from the inverter on DC bus 106 connecting the inverter 108 and the circuit portion 310 by superimposing a pulsed waveform). Thus, the system 300 may include a passive inverter 108 and may omit the inverter controller 112.

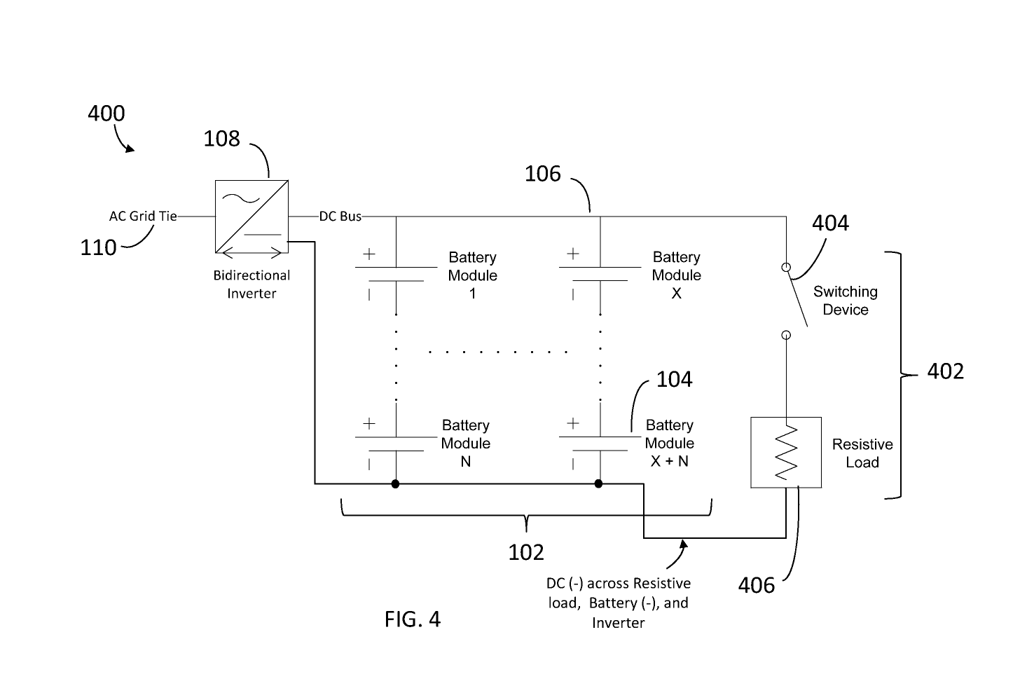

FIG. 4 illustrates an alternative embodiment system 400 containing an alternative pulse apparatus 402. The pulse apparatus 402 may include a resistive load 406 modulated via a power switching device 404. The switching device 404 may be electrically connected to a battery collection 102 including at least one battery module 104 by a DC bus 106. The DC bus 106 may be connected to a power grid 110 via a bidirectional inverter 108, as shown in FIG. 3.

The switching device 404 may include various different electrical gates or switches (e.g., transistors, relay, or any other electrical or mechanical switch) and may be controlled by various logic circuits. The resistive load 406 (e.g., resistor) may simply absorb the energy discharged from the battery modules 104 during the anodic pulses. Various different resistive loads may be used in alternate embodiments.

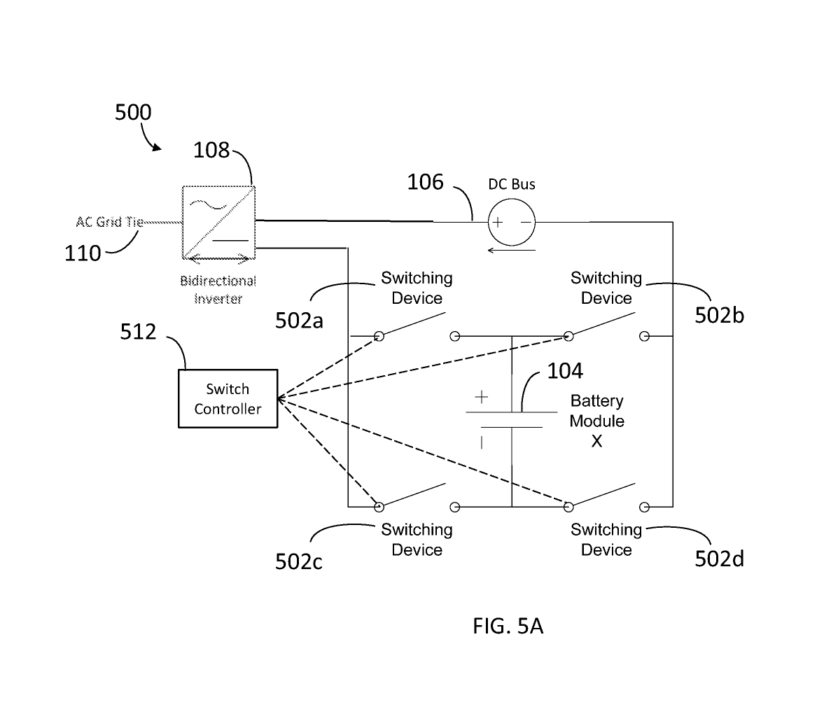

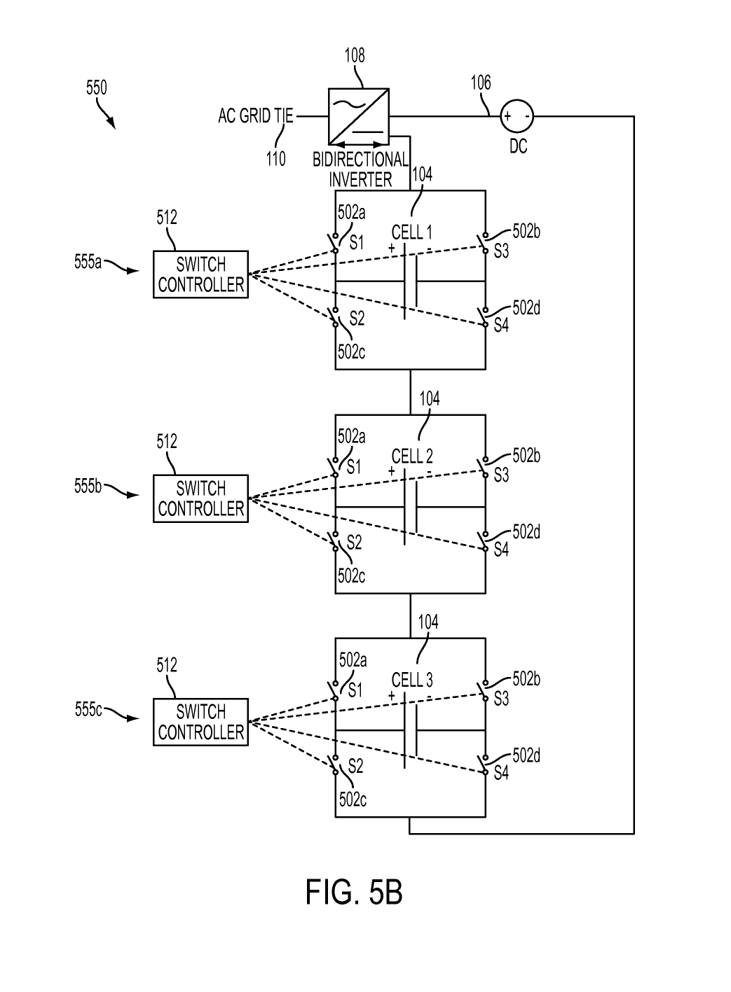

FIG. 5A illustrates another alternative embodiment system 500 with another alternative pulse apparatus. The pulse apparatus may be an H-Bridge circuit placed around one or more battery modules 104. The H-Bridge circuit may include multiple switches, such as switching devices 502a-d, in order to allow for the current path to rapidly switch between charge and discharge. Although FIG. 5A illustrates a single battery module 104, in alternate embodiments, H-circuits may be placed around any number of battery modules of a battery collection.

In various embodiments, the switching devices 502a-d may be various different types of switches and may be open or closed by various logic circuits (e.g., switch controller 512). When switches 502a and 502d are closed and switches 502b and 502c are open, a positive voltage may be applied across the battery or batteries. By opening switches 502a and 502d and closing switches 502b and 502c, this voltage may be reversed, allowing reverse charging of the battery or batteries.

FIG. 5B illustrates an embodiment system 550 with multiple H-Bridge circuits. FIG. 5B includes three H-Bridge circuits 555a-c but alternate embodiments may include more. Similar to the circuit in FIG. 5A, each H-Bridge may be placed around one or more battery modules 104 and may include switching devices 502a-d. FIG. 5B illustrates separate switch controllers 512 for each H-Bridge, but in alternate embodiments there may be one or more shared switch controllers.

The battery modules 104 may be pulse charged by opening and closing alternate sets of switches 502a and 502d and switches 502b and 502d to rapidly switch between charging and discharging as discussed above. In various embodiments, the current and/or voltage on the DC bus 106 drawn from the grid 110 may be kept constant by coordinating which H-Bridge circuits are charging or discharging (i.e., the switch controllers 512 may be coordinated such that switches 502a and 502d are closed and switches 502b and 502c are open in one or more H-Bridge circuits while switches 502a and 502d are open and switches 502b and 502c are closed in the remaining H-Bridge circuits or vice versa).

For example, initially, H-Bridge circuit 555a may discharge while H-Bridge circuits 555b and 555c charge. The switching devices 502a-d may then periodically switch to rotate or alternate which circuit is discharging, such as discharging H-Bridge 555b while charging H-Bridge circuits 555a and 555c or discharging H-Bridge 555c while charging H-Bridge circuits 555a and 555b. Various patterns or routines of discharging and charging the different H-Bridge circuits may be used in alternate embodiments.

Although different H-bridge circuits are being alternately charged and discharged in the example above, the current and/or voltage on the DC bus 106 drawn from the AC grid tie 110 may be kept substantially constant by maintaining substantially the same total charging load over any given time period (e.g., 1 ms to 100 s, 10 ms to 1 s, 100 ms-10 s, 1 s-100 s, 1 s-10 s). The term “substantially” provides a 0-10% variation in the current, voltage and/or load over time. This total charging load may be distributed through different H-Bridge circuits or even different numbers of H-Bridge circuits depending how the battery modules 104 are distributed.

In various embodiments, the pulse apparatus (e.g., 302, 402, 502a-d) may function independently of a power conversion device, such as bidirectional inverter 108. Since the inverter 108 is not responsible for pulsing between charge and discharge, the grid current may be constant during charging of battery modules 104.

In various embodiments, the battery collection 102 may be composed of a number of series or parallel connected battery modules 104. For example, at least two battery modules 104 may be connected in parallel, at least two battery modules 104 may be connected in series, or battery modules 104 may be connected in any combination of series or parallel arrangement.

Various embodiments may include switching devices (e.g., 404, 502a-d) that are controlled by logic or control circuits (e.g., 512). These control circuits may include various adjustable control signal circuits, tunable circuits, or user interfaces to control the pulse frequency, duty cycle, magnitude, or other characteristic features of the pulse waveform for charging the battery or batteries. Control elements may be implemented using computing devices (such as computer) comprising processors, memory and other components that have been programmed with instructions to perform specific functions or may be implemented in processors designed to perform the specified functions. A processor may be any programmable microprocessor, microcomputer or multiple processor chip or chips that can be configured by software instructions (applications) to perform a variety of functions, including the functions of the various embodiments described herein. In some computing devices, multiple processors may be provided. Typically, software applications may be stored in the internal memory before they are accessed and loaded into the processor. In some computing devices, the processor may include internal memory sufficient to store the application software instructions.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A system for pulse charging a battery, comprising:
a battery module;
an inverter; and
a pulse apparatus connected to the inverter and the battery module and configured to pulse charge the battery module by modulating a power output from the inverter.

2. The system of claim 1, wherein the pulse apparatus is configured to control at least one of frequency, duty cycle, and amplitude of the pulse charging of the battery module.

3. The system of claim 1, further comprising a battery collection including the battery module, and wherein the pulse apparatus is configured to pulse charge the battery collection.

4. The system of claim 3, wherein the battery module is a flow battery module.

5. The system of claim 3, wherein the battery collection comprises at least two battery modules connected in parallel.

6. The system of claim 3, wherein the battery collection comprises at least two battery modules connected in series.

7. The system of claim 1, wherein the pulse apparatus comprises a regenerative DC chopper circuit.

8. The system of claim 1, wherein the pulse apparatus comprises a resistive load connected to the battery module via a power switching device.

9. The system of claim 1, wherein the pulse apparatus comprises an H-bridge circuit.

10. The system of claim 1, wherein the inverter is a bidirectional inverter tied to a power grid and is configured to draw constant power output from the power grid while charging the battery module.

11. A method of pulse charging a battery module, comprising:
converting AC power output from a power grid to constant DC power;
modulating the constant DC power to produce modulated power; and
providing the modulated power to the battery module to pulse charge the battery module.

12. The method of claim 11, wherein modulating the constant DC power comprises superimposing a pulsed waveform of anodic and cathodic pulses on the constant DC power with a pulse apparatus.

13. The method of claim 12, wherein the pulse apparatus comprises a regenerative DC chopper circuit which absorbs and returns power during anodic and cathodic pulses respectively.

14. The method of claim 12, wherein the pulse apparatus comprises a resistive load connected to the battery module via a power switching device which closes and opens during anodic and cathodic pulses respectively.

15. The method of claim 12, wherein:
the pulse apparatus comprises a plurality of H-Bridge circuits;
different H-bridge circuits of the plurality of H-Bridge circuit are being alternately charged and discharged;
the AC power output comprises at least one of current or voltage drawn from the power grid; and
the constant DC power comprises the current or voltage which is kept substantially constant by maintaining substantially the same total charging load over time.

16. The method of claim 11, wherein modulating the constant DC power comprises superimposing a pulsed waveform on the constant DC power with a pulse apparatus, the pulse waveform being at least one of cathodic pulses followed by no current, direct current with superimposed modulations, duplex pulse, pulse on pulse, pulse reverse current, high frequency pulse with superimposed periodic reverse current, modified sine wave pulse, and square wave pulse.

17. The method of claim 11, wherein the battery module is a flow battery module.

18. The method of claim 11, further comprising providing the modulated power to a battery collection to pulse charge the battery collection, wherein the battery collection includes the battery module.

19. The method of claim 18, wherein the battery collection comprises at least two battery modules connected in parallel.

20. The method of claim 18, wherein the battery collection comprises at least two battery modules connected in series.
